(19) United States
(12) Patent Application Publication
(10) Pub. No.: US 2025/0184676 A1
(43) Pub. Date: Jun. 5, 2025

(54) HEARING AID DEVICE

(71) Applicant: SHENZHEN SHOKZ CO., LTD., Shenzhen (CN)

(72) Inventor: Song YANG, Shenzhen (CN)

(73) Assignee: SHENZHEN SHOKZ CO., LTD., Shenzhen (CN)

(21) Appl. No.: 19/050,048

(22) Filed: Feb. 10, 2025

Related U.S. Application Data
(63) Continuation of application No. PCT/CN2023/090355, filed on Apr. 24, 2023.

(51) Int. Cl. H04R 25/00

(52) U.S. Cl. CPC H04R 25/603; H04R 25/558; H04R 2225/31; H04R 2225/33; H04R 2225/61; H04R 2420/07

(57) ABSTRACT

This disclosure provides a hearing aid device that mixes a hearing aid audio signal output by a hearing aid component and a Bluetooth audio signal output by a Bluetooth component by an audio mixing circuit, thereby integrating Bluetooth functionality with hearing aid functionality. It not only enables hearing aid functionality but also supports Bluetooth phone calls and Bluetooth music functions of Bluetooth headsets, allowing the combined use of hearing aid functionality and Bluetooth headset functions.

### RELATED APPLICATIONS

This application is a continuation application of PCT application No. PCT/CN2023/090355, filed on Apr. 24, 2023, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to the technical field of wireless headphones, and more particularly to a hearing aid device.

### BACKGROUND

With the intensification of population aging, hearing aids have helped an increasing number of individuals with hearing impairments to hear the world more clearly. At the same time, with the development of the consumer electronics industry, activities such as making phone calls, listening to music, and watching videos have become deeply integrated into people's lives. Traditional hearing aids, however, are limited to hearing assistance functions. In situations such as making phone calls or listening to music, they are not very convenient and often disrupt the lives of individuals with hearing impairments.

Therefore, a new hearing aid device is needed that not only provides hearing assistance functions but also supports Bluetooth phone calls and Bluetooth music like Bluetooth headphones. Additionally, it should enable the combined use of hearing assistance and Bluetooth headphone functions.

### SUMMARY

This disclosure provides a hearing aid device that simplifies user operation steps and enhances user experience during the use of the hearing aid device.

In an aspect, this disclosure provides a hearing aid device, including: a hearing aid component, configured to collect an external sound and perform a first signal processing during an operation, and output a hearing aid audio signal; a Bluetooth component, configured to receive an external audio signal and perform a second signal processing during the operation, and output a Bluetooth audio signal; an audio mixing circuit, electrically connected to the hearing aid component and the Bluetooth component, and configured to mix the hearing aid audio signal and the Bluetooth audio signal during the operation; and a speaker, electrically connected to the audio mixing circuit.

From the above technical solution, it can be seen that the hearing aid device provided in this disclosure integrates the Bluetooth functionality and hearing assistance functionality by mixing the hearing aid audio signal output by the hearing aid component with the Bluetooth audio signal output by the Bluetooth component via an audio mixing circuit. This integration not only achieves hearing assistance functionality but also supports Bluetooth phone calls and Bluetooth music playback, and allows the combined use of hearing assistance and Bluetooth functionalities. The hearing aid device provided in this disclosure can also control the connection and disconnection of the control switch circuit between the hearing aid component and the audio mixing circuit through the Bluetooth component, thereby controlling the connection and disconnection of the hearing aid component and the audio mixing circuit. This enables the device to support either Bluetooth functionality alone or the simultaneous use of Bluetooth and hearing assistance functionalities, thereby expanding the application scenarios of the hearing aid device. Users can switch modes according to different occasions to achieve a better experience. Additionally, the hearing aid device provided in this disclosure can be controlled through the Bluetooth component, eliminating the need to redesign the hearing aid component. This not only reduces costs but also maintains the quality of the hearing experience.

The additional features of the hearing aid device provided in this disclosure will be partially listed in the following description. The inventive aspects of the hearing aid device provided in this disclosure can be fully explained through practice or by using the methods, devices, and combinations described in the detailed examples below.

### BRIEF DESCRIPTION OF THE DRAWINGS

To provide a clearer explanation of the technical solutions in the embodiments of this disclosure or the existing technology, a brief introduction to the drawings used in the descriptions of the embodiments of the present application or the existing technology is provided below. It is evident that the drawings described below pertain to some exemplary embodiments of this disclosure. For a person skilled in the art, additional drawings can be derived from these without requiring creative efforts.

FIG. 1 is a schematic diagram of an application scenario of a hearing aid device provided according to some exemplary embodiments of this disclosure;

FIG. 2 is a schematic diagram of the hardware of a hearing aid device provided according to some exemplary embodiments of this disclosure; and

FIG. 3 is a schematic diagram of the hardware of a hearing aid device provided according to some exemplary embodiments of this disclosure.

### DETAILED DESCRIPTION

The following description provides specific application scenarios and requirements of this disclosure, with the aim of enabling those skilled in the art to manufacture and use the content of this disclosure. For those skilled in the art, various local modifications to the disclosed embodiments are apparent, and the general principles defined here can be applied to other embodiments and applications without departing from the spirit and scope of this disclosure. Therefore, this disclosure is not limited to the embodiments shown but is intended to cover the broadest scope consistent with the claims.

The terms used herein are for the purpose of describing specific example embodiments and are not meant to be restrictive. For example, unless otherwise explicitly stated in the context, the singular forms “a,” “an,” and “the” may also include the plural forms. When used in this disclosure, the terms “include,” “comprise,” and/or “contain” mean that the associated integer, step, operation, element, and/or component is present but do not exclude the presence of one or more other features, integers, steps, operations, elements, components, and/or groups, or the possibility of adding other features, integers, steps, operations, elements, components, and/or groups to the system/method.

Given the following description, these features and other features of the disclosure, as well as the operation and functionality of the related elements of the structure, and the combination and manufacturability of the parts, can be significantly improved. The accompanying drawings, which form part of this disclosure, are referenced for illustration. However, it should be clearly understood that the drawings are for illustration and description purposes only and are not intended to limit the scope of this disclosure. It should also be understood that the drawings are not drawn to scale.

The flowcharts used in this disclosure illustrate the operations of the system implementation according to some exemplary embodiments of this disclosure. It should be clearly understood that the operations in the flowcharts may not be implemented in a specific order. Instead, the operations may be performed in reverse order or concurrently. Additionally, one or more other operations may be added to the flowcharts, or one or more operations may be removed from them.

The hearing device provided in this disclosure may include a left ear hearing device and a right ear hearing device. The left ear hearing device and the right ear hearing device are respectively used for the left ear and the right ear. In some exemplary embodiments, the left ear hearing device and the right ear hearing device may also be used interchangeably. The audio signal processing of the left ear hearing device and the right ear hearing device can be consistent or inconsistent. For example, when the hearing ability of the left ear and the right ear is inconsistent, the audio signal processing of the left ear hearing device and the right ear hearing device can be inconsistent. In some exemplary embodiments, the left ear hearing device and the right ear hearing device may be physically connected, for example, by means of a connecting housing. In this case, signal connection between the left ear hearing device and the right ear hearing device can be achieved via circuitry. In some exemplary embodiments, the left ear hearing device and the right ear hearing device may be set up independently of each other. In this case, signal connection between the left ear hearing device and the right ear hearing device can be achieved through wireless communication. In some exemplary embodiments, the left ear hearing device and the right ear hearing device may also be used independently or as a pair. When the left ear hearing device and the right ear hearing device are used independently, the hearing device operates in a monoaural mode. When the left ear hearing device and the right ear hearing device are paired for use, the hearing device operates in a binaural mode.

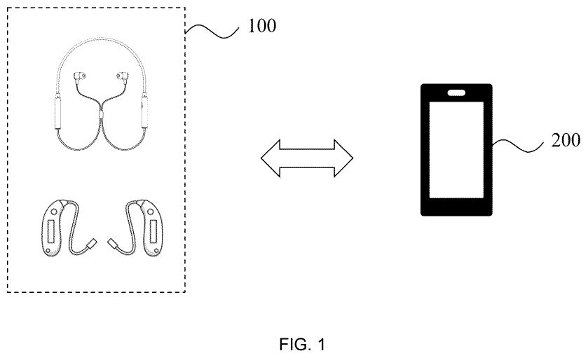

FIG. 1 is a schematic diagram of an application scenario for a hearing device 100 provided according to some exemplary embodiments of this disclosure. As shown in FIG. 1, the hearing device 100 can communicate with an electronic device 200 via Bluetooth.

The electronic device 200 can be an electronic device with audio output functionality, also referred to as an audio output device. In some exemplary embodiments, the electronic device 200 may include mobile devices, tablets, laptops, built-in devices of motor vehicles, or similar devices, or any combination thereof. In some exemplary embodiments, the mobile device may include smart home devices, smart mobile devices, virtual reality devices, augmented reality devices, or similar devices, or any combination thereof. In some exemplary embodiments, the smart home devices may include smart TVs, desktop computers, smart speakers, etc., or any combination thereof. In some exemplary embodiments, the smart mobile devices may include smartphones, personal digital assistants, gaming devices, navigation devices, etc., or any combination thereof. In some exemplary embodiments, the virtual reality or augmented reality devices may include virtual reality headsets, virtual reality glasses, virtual reality controllers, augmented reality headsets, augmented reality glasses, augmented reality controllers, or similar devices, or any combination thereof. For example, the virtual reality or augmented reality devices may include Google Glass, head-mounted displays, VR, etc. In some exemplary embodiments, the built-in devices in motor vehicles may include onboard computers, in-car TVs, etc. In some exemplary embodiments, the electronic device 200 may include audio collection devices to capture audio data in the target space, thus obtaining audio data to be played. In some exemplary embodiments, the electronic device 200 may receive audio data to be played from other devices.

The hearing device 100 can support the Bluetooth protocol, and the electronic device 200 can be an audio output device that supports the Bluetooth protocol. Communication between the hearing device 100 and the electronic device 200 can be based on the Bluetooth protocol for audio data transmission.

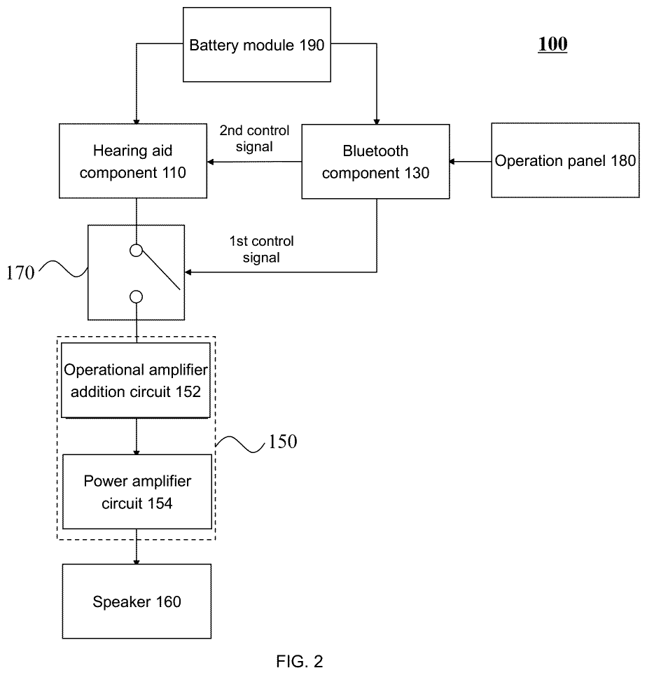

FIG. 2 is a hardware schematic diagram of a hearing device 100 provided according to some exemplary embodiments of this disclosure. As shown in FIG. 2, the hearing device 100 may include a hearing aid component 110, a Bluetooth component 130, an audio mixing circuit 150, and a speaker 160. In some exemplary embodiments, the hearing device 100 may further include a control switch circuit 170. In some exemplary embodiments, the hearing device 100 may also include an operation panel 180. In some exemplary embodiments, the hearing device 100 may also include a battery module 190.

The hearing aid component 110 can capture external sounds and perform first signal processing during operation, outputting hearing aid audio signals. The external sounds may include sounds near the user, including but not limited to the user's own speech, sounds in the user's environment (such as other people's speech, ambient sounds), and so on. The first signal processing may include, but is not limited to, noise reduction processing, amplification processing, speech enhancement processing, frequency response compensation processing, and similar processes using appropriate algorithms.

The Bluetooth component 130 can receive external audio signals during operation, perform second signal processing, and output Bluetooth audio signals. The Bluetooth component 130 can establish a Bluetooth connection with the electronic device 200 for data transmission. The external audio signals may refer to audio data transmitted from the electronic device 200 to the Bluetooth component 130. In some exemplary embodiments, the Bluetooth component 130 can also capture the user's voice, process the signals, and send them to the electronic device 200. In some exemplary embodiments, the Bluetooth component 130 can be electrically connected to the hearing aid component 110. When operating, the Bluetooth component 130 can control the hearing aid component 110 based on a second control signal, thereby managing the first signal processing performed by the hearing aid component 110. For example, the Bluetooth component 130 can control the hearing aid component 110 to enhance or attenuate the audio signal based on the second control signal during operation.

The audio mixing circuit 150 can be electrically connected to the hearing aid component 110 and the Bluetooth component 130. During operation, it mixes the hearing aid audio signal and the Bluetooth audio signal, enabling the hearing device 100 to simultaneously support both hearing aid functionality and Bluetooth headset functionality. The audio mixing circuit 150 can superimpose the hearing aid audio signal and the Bluetooth audio signal, allowing the user to hear both signals simultaneously. In some exemplary embodiments, the audio mixing circuit 150 can directly superimpose the hearing aid audio signal and the Bluetooth audio signal. In other embodiments, the audio mixing circuit 150 may process the hearing aid audio signal and the Bluetooth audio signal before superimposing them. The processing may include amplifying or attenuating the signals of the hearing aid audio signal and/or the Bluetooth audio signal to adjust their relative signal strengths, ensuring balance and preventing one signal from overpowering the other. For instance, the audio mixing circuit 150 may first compare the signal strengths of the hearing aid audio signal and the Bluetooth audio signal and then adjust their intensities based on the comparison results. The superimposition process can involve linear averaging or weighted summation.

As shown in FIG. 1, the audio mixing circuit 150 may include an operational amplifier addition circuit 152 and a power amplifier circuit 154. The operational amplifier addition circuit 152 can be electrically connected to the hearing aid component 110 and the Bluetooth component 130 to mix the hearing aid audio signal and the Bluetooth audio signal during operation. The power amplifier circuit 154, electrically connected to the operational amplifier addition circuit 152, amplifies the signals output by the operational amplifier addition circuit during operation.

The speaker 160 can be electrically connected to the audio mixing circuit 150. During operation, the speaker 160 receives the mixed audio signal output by the audio mixing circuit 150 and converts the mixed audio signal into sound for playback. When the user wears the hearing device 100, the speaker 160 can be positioned close to the user's ear canal, allowing the user to hear the sound as it plays. The speaker 160 may be a bone conduction speaker and/or an air conduction speaker. When the speaker 160 is a bone conduction speaker, the vibration signals it generates are transmitted through the user's skin and bones to the auditory nerve, enabling the user to perceive the sound. When the speaker 160 is an air conduction speaker, the sound signals it generates are transmitted through the air and eardrum to the auditory nerve, allowing the user to hear the sound. Alternatively, the speaker 160 can include both a bone conduction speaker and an air conduction speaker, simultaneously producing vibration signals and air-conducted sound signals.

The hearing device 100 provided in this disclosure integrates the Bluetooth component 130 with the hearing aid component 110. Through the design of the audio mixing circuit 150, the processed hearing aid audio signal and the Bluetooth audio signal are mixed and superimposed, then output to the speaker 160 for playback. The hearing device 100 described in this disclosure does not require a redesign of the hearing aid component 110 or the first signal processing within it. Instead, the Bluetooth component 130 and the audio mixing circuit 150 can be directly integrated with the existing hearing aid component 110. This integration preserves the high-quality signal processing of the original hearing aid component 110 while adding Bluetooth functionality. It provides multifunctionality while maintaining the hearing experience.

As shown in FIG. 1, in some exemplary embodiments, the hearing device 100 may also include a control switch circuit 170. The control switch circuit 170 can be electrically connected to both the hearing aid component 110 and the audio mixing circuit 150. Specifically, the control switch circuit 170 can connect or disconnect the hearing aid component 110 and the audio mixing circuit 150, thereby controlling their interaction. When the control switch circuit 170 is disconnected, the connection between the hearing aid component 110 and the audio mixing circuit 150 is severed, and the hearing aid audio signal output by the hearing aid component 110 cannot be input to the audio mixing circuit 150. Conversely, when the control switch circuit 170 is connected, the hearing aid component 110 and the audio mixing circuit 150 are electrically connected, allowing the hearing aid audio signal output by the hearing aid component 110 to be input to the audio mixing circuit 150. The control switch circuit 170 can also be signal-connected to the Bluetooth component 130. During operation, the Bluetooth component 130 can control the connection and disconnection of the control switch circuit 170 based on a first control signal, thereby managing the connection between the hearing aid component 110 and the audio mixing circuit 150. The control switch circuit 170 can be any type of switch circuit, such as voltage-controlled or current-controlled, without limitation in this disclosure.

The hearing device 100 provided in this disclosure can have a control switch circuit 170 set between the hearing aid component 110 and the audio mixing circuit 150, and the connection and disconnection of the control switch circuit 170 can be controlled by the Bluetooth component 130, allowing the hearing device 100 to automatically or manually switch between multiple operating modes. For example, when the Bluetooth connection between the Bluetooth component 130 and the electronic device 200 is disconnected, and the control switch circuit 170 is connected, the hearing device 100 operates in hearing aid mode, realizing hearing aid functionality. In another example, when the Bluetooth connection between the Bluetooth component 130 and the electronic device 200 is established, and the control switch circuit 170 is closed, the hearing device 100 operates in a mixed mode, realizing both hearing aid functionality and Bluetooth functionality, allowing the user to enjoy Bluetooth functionality while also benefiting from hearing aid functionality, avoiding missing important external sound information. In yet another example, when the Bluetooth connection between the Bluetooth component 130 and the electronic device 200 is established, and the control switch circuit 170 is disconnected, the hearing device 100 operates in Bluetooth mode, realizing Bluetooth functionality, allowing the user to enjoy Bluetooth functionality while avoiding disturbances from the external environment.

As shown in FIG. 1, in some exemplary embodiments, the hearing aid device 100 may further include an operation panel 180. The operation panel 180 can be electrically connected to the Bluetooth component 130 and generate corresponding operation instructions in response to user actions during operation. The Bluetooth component 130 can generate corresponding control signals based on the operation instructions during its operation. The control signals may include the first control signal and/or the second control signal. The user's actions include, but are not limited to, adjusting the volume, such as increasing or decreasing the volume, including adjusting the volume of the hearing aid audio signal and the Bluetooth audio signal. In some exemplary embodiments, the user's actions may also include switching the working mode of the hearing aid device 100, such as operating the control switch circuit 170 to control the connection or disconnection of the control switch circuit 170, thus controlling the connection or disconnection between the hearing aid component 110 and the audio mixing circuit 150 to switch the mode of the hearing aid device 100. In some exemplary embodiments, the user's actions may also include pause and play operations, and controlling the Bluetooth connection and disconnection. In some exemplary embodiments, the user's actions may also include other operations, such as turning on and off the noise reduction mode, switching the noise reduction mode, etc. The operation panel 180 may be button-based, such as mechanical buttons, touch buttons, etc. The operation panel 180 may also support voice operation, gesture operation, etc., and this disclosure does not limit it.

As shown in FIG. 1, in some exemplary embodiments, the hearing aid device 100 may further include a battery module 190. The battery module 190 can be electrically connected to the Bluetooth component 130 and the hearing aid component 110, providing power to the Bluetooth component 130 and the hearing aid component 110.

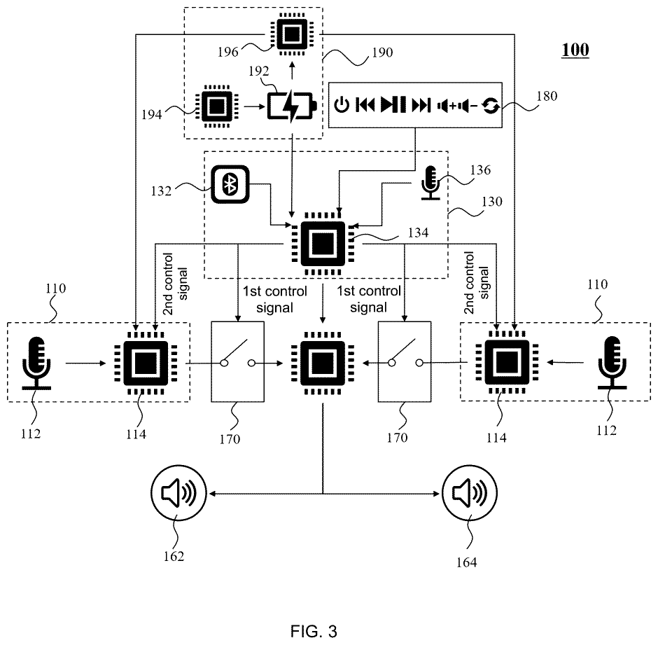

As mentioned earlier, the hearing aid device 100 can operate in a single-ear mode or a dual-ear mode. For ease of presentation, we will describe the dual-ear mode as an example. A person skilled in the art should understand that the single-ear mode is a part of the dual-ear mode and is also within the scope of this disclosure. FIG. 3 illustrates a hardware schematic of a hearing aid device 100 according to an embodiment of this disclosure. As shown in FIG. 3, the hearing aid component 110 may include a hearing aid microphone 112 and a hearing aid signal processing circuit 114.

The hearing aid microphone 112 can be the audio capture device of the hearing aid component 110. When operating, the hearing aid microphone 112 can capture external sounds and generate a hearing aid microphone signal, which is an electronic signal carrying audio information. The external sounds, as mentioned earlier, will not be repeated here. Since the hearing aid microphone 112 is used to capture external sounds, its position can be placed closer to the user's ear. The hearing aid microphone 112 can be a single microphone or a microphone array. When the hearing aid microphone 112 is a microphone array, it can include multiple microphones arranged in a preset array shape. The multiple microphones can be evenly distributed or unevenly distributed. In some exemplary embodiments, the multiple microphones can be arranged in a linear distribution. In some exemplary embodiments, the multiple microphones can also be arranged in other shapes, such as circular arrays, rectangular arrays, and so on.

The hearing aid microphone 112 can be a bone conduction microphone and/or an air conduction microphone. The bone conduction microphone directly captures mechanical vibration signals caused by external sounds and converts these vibration signals into electrical signals. The bone conduction microphone may include vibration sensors, such as optical vibration sensors, accelerometers, etc. The vibration sensor can capture mechanical vibration signals (for example, signals generated by vibrations from the skin or bones when the user speaks) and convert these mechanical vibration signals into electrical signals. The mechanical vibration signals referred to here mainly refer to vibrations transmitted through solids. The bone conduction microphone makes contact with the user's skin or bones through the vibration sensor or a vibrating component connected to the vibration sensor, thus capturing the vibration signals generated by the bones or skin when the user produces sound. The air conduction microphone directly captures air vibration signals caused by external sounds and converts these air vibration signals into electrical signals.

In the dual-ear mode, the hearing aid microphone 112 can include two hearing aid microphones 112, one for the left ear and one for the right ear.

The hearing aid signal processing circuit 114 can be electrically connected to the hearing aid microphone 112. When operating, the hearing aid signal processing circuit 114 processes the hearing aid microphone signal with the first signal processing and outputs the hearing audio signal. The hearing aid signal processing circuit 114 can be electrically connected to the Bluetooth component 130 and receive the second control signal. The hearing aid signal processing circuit 114 can be an integrated circuit (IC) chip, such as the E7111, BS300, EZ7100, etc. In the dual-ear mode, the hearing aid signal processing circuit 114 can include two hearing aid signal processing circuits 114, one for the left ear's hearing aid microphone and one for the right ear's hearing aid microphone.

The Bluetooth component 130 can include a Bluetooth communication module 132 and a Bluetooth signal processing circuit 134. When operating, the Bluetooth communication module 132 can connect to an electronic device 200 via Bluetooth for wireless data transmission. When operating, the Bluetooth communication module 132 can receive external audio signals, such as audio signals sent by the electronic device 200. The Bluetooth signal processing circuit 134 can be electrically connected to the Bluetooth communication module 132. When operating, the Bluetooth signal processing circuit 134 processes the external audio signals with the second signal processing and outputs the Bluetooth audio signal. The Bluetooth signal processing circuit 134 is electrically connected to the hearing aid signal processing circuit 114 and sends the second control signal to the hearing aid signal processing circuit 114. The Bluetooth signal processing circuit 134 can be an IC chip, such as the QCC3024, QCC512X, BES2500, and other series.

The Bluetooth component 130 may also include a Bluetooth microphone 136. The Bluetooth microphone 136 can be the audio capture device of the Bluetooth component 130. When operating, the Bluetooth microphone 136 can capture external sounds and generate a Bluetooth microphone signal, which is an electronic signal carrying audio information. The Bluetooth microphone 136 is primarily used to capture the user's voice, so its position can be placed closer to the user's mouth. The Bluetooth microphone 136 can be electrically connected to the Bluetooth signal processing circuit 134. When operating, the Bluetooth signal processing circuit 134 can perform third signal processing on the Bluetooth microphone signal, generate an output audio signal, and send it to the Bluetooth communication module 132. The Bluetooth communication module 132 can send the audio signal to the electronic device 200. The Bluetooth microphone 136 can be a single microphone or a microphone array. When the Bluetooth microphone 136 is a microphone array, it can include multiple microphones arranged in a preset array shape. The multiple microphones can be evenly distributed or unevenly distributed. In some exemplary embodiments, the multiple microphones can be arranged in a linear distribution. In some exemplary embodiments, the multiple microphones can also be arranged in other shapes, such as circular arrays, rectangular arrays, and so on. The Bluetooth microphone 136 can be a bone conduction microphone and/or an air conduction microphone. In the dual-ear mode, the Bluetooth microphone 136 can include two Bluetooth microphones 136, one for the left ear and one for the right ear, or it can include just one Bluetooth microphone 136 for the left ear or right ear.

As shown in FIG. 3, in the dual-ear mode, the speaker 160 can include a left speaker 162 and a right speaker 164. The left speaker 162 and the right speaker 164 can be used for the left ear and the right ear, respectively.

As shown in FIG. 3, the battery module 190 can include a rechargeable battery 192, a charging protection circuit 194, and a voltage regulation circuit 196. The rechargeable battery 192 can be electrically connected to the Bluetooth component 130 and the hearing aid component 110, providing power to the Bluetooth component 130 and the hearing aid component 110 during operation. The charging protection circuit 194 can be electrically connected to the rechargeable battery 192. The voltage regulation circuit 196 can connect the hearing aid component 110 to the rechargeable battery 192. The hearing aid device 100 provided in this disclosure is equipped with a rechargeable battery, avoiding the need for battery replacement, making it more convenient and environmentally friendly.

In summary, the hearing aid device 100 provided in this disclosure mixes the hearing aid audio signal output by the hearing aid component 110 and the Bluetooth audio signal output by the Bluetooth component 130 through the audio mixing circuit 150, thereby integrating the Bluetooth function and the hearing aid function. This allows not only the hearing aid function but also the Bluetooth headset functions for Bluetooth calls and Bluetooth music, and the simultaneous use of both the hearing aid function and the Bluetooth headset function. The hearing aid device 100 provided in this disclosure can also control the connection and disconnection of the control switch circuit 170, which connects the hearing aid component 110 to the audio mixing circuit 150, via the Bluetooth component 130. This controls the connection and disconnection of the hearing aid component 110 and the audio mixing circuit 170, thereby enabling scenarios where only Bluetooth functionality is supported or both Bluetooth and hearing aid functions are used together. This expands the use cases of the hearing aid device 100, allowing the user to switch the device mode based on different situations for a better experience. At the same time, the hearing aid device 100 provided in this disclosure can be controlled via the Bluetooth component 130 without the need to redesign the hearing aid component 110, reducing costs while maintaining the hearing aid experience.

The specific embodiments of the present disclosure have been described above. Other embodiments are within the scope of the appended claims. In some cases, the actions or steps recited in the claims can be performed in an order different from that in the embodiments and still achieve the desired results. Additionally, the processes depicted in the drawings do not necessarily require the specific order or consecutive sequence to achieve the desired results. In certain embodiments, multitasking and parallel processing are also possible or may be advantageous.

In summary, after reading this detailed disclosure, those skilled in the art will understand that the detailed content provided above can be presented in an exemplary manner and is not restrictive. Although not explicitly stated here, those skilled in the art will understand that various reasonable changes, improvements, and modifications to the embodiments may be encompassed by this disclosure. These changes, improvements, and modifications are intended to be within the spirit and scope of the exemplary embodiments presented in this disclosure.

In addition, certain terms in this disclosure have been used to describe the embodiments of the disclosure. For example, the terms “one embodiment,” “embodiment,” and/or “some exemplary embodiments” mean that specific features, structures, or characteristics described in connection with that embodiment may be included in at least one embodiment of the disclosure. Therefore, it should be emphasized and understood that references to “embodiment,” “one embodiment,” or “alternative embodiment” in various parts of this disclosure do not necessarily refer to the same embodiment. Additionally, specific features, structures, or characteristics may be appropriately combined in one or more embodiments of the disclosure.

It should be understood that in the foregoing description of the embodiments of the disclosure, in order to aid in understanding a feature and simplify the presentation, various features are combined in a single embodiment, drawing, or description. However, this does not mean that the combination of these features is required. A person skilled in the art, upon reading this disclosure, could very well consider part of the equipment marked as a separate embodiment. In other words, the embodiments in this disclosure can also be understood as the integration of multiple sub-embodiments. And each sub-embodiment is valid even when it includes fewer features than a single full embodiment disclosed above.

Each patent, patent application, publication of a patent application, and other materials, such as articles, books, disclosures, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

Finally, it should be understood that the embodiments of the application disclosed herein are illustrative of the principles of the embodiments of this disclosure. Other modified embodiments are also within the scope of this disclosure. Therefore, the embodiments disclosed in this disclosure are merely examples and not limitations. Those skilled in the art can adopt alternative configurations based on the embodiments in this disclosure to implement the application in this disclosure. Thus, the embodiments of this disclosure are not limited to the embodiments described in the application in precise detail.

What is claimed is:

1. A hearing aid device, comprising:
a hearing aid component, configured to collect an external sound and perform a first signal processing during an operation, and output a hearing aid audio signal;
a Bluetooth component, configured to receive an external audio signal and perform a second signal processing during the operation, and output a Bluetooth audio signal;
an audio mixing circuit, electrically connected to the hearing aid component and the Bluetooth component, and configured to mix the hearing aid audio signal and the Bluetooth audio signal during the operation; and
a speaker, electrically connected to the audio mixing circuit.

2. The hearing aid device according to claim 1, wherein the audio mixing circuit comprises:
an operational amplifier summing circuit, electrically connected to the hearing aid component and the Bluetooth component, and configured to mix the hearing aid audio signal and the Bluetooth audio signal during the operation; and
a power amplifier circuit, electrically connected to the operational amplifier summing circuit, and configured to amplify a signal output by the operational amplifier summing circuit during the operation.

3. The hearing aid device according to claim 1, further comprising:
a control switch circuit, electrically connected to the hearing aid component and the audio mixing circuit, respectively, to control connection and disconnection between the hearing aid component and the audio mixing circuit.

4. The hearing aid device according to claim 3, wherein the control switch circuit is signal-connected to the Bluetooth component, and the Bluetooth component controls connection and disconnection of the control switch circuit based on a first control signal during the operation, thereby controlling the connection and disconnection between the hearing aid component and the audio mixing circuit.

5. The hearing aid device according to claim 4, further comprising:
an operation panel, electrically connected to the Bluetooth component, and configured to generate an operation command in response to a user operation during the operation, wherein
the Bluetooth component, during the operation, generates a corresponding control signal based on the operation command, and the corresponding control signal comprises the first control signal.

6. The hearing aid device according to claim 1, wherein the Bluetooth component is electrically connected to the hearing aid component, and the Bluetooth component controls the hearing aid component based on a second control signal during the operation.

7. The hearing aid device according to claim 6, further comprising:
an operation panel, electrically connected to the Bluetooth component, and configured to generate an operation command in response to a user operation during the operation, wherein
the Bluetooth component, during the operation, generates a corresponding control signal based on the operation command, and the corresponding control signal comprises the second control signal.

8. The hearing aid device according to claim 6, wherein the hearing aid component comprises:
a hearing aid microphone, configured to collect the external sound during the operation and generate a hearing aid microphone signal; and
a hearing aid signal processing circuit, electrically connected to the hearing aid microphone, and configured to perform the first signal processing on the hearing aid microphone signal during the operation and output the hearing aid audio signal, wherein
the hearing aid signal processing circuit is electrically connected to the Bluetooth component to receive the second control signal.

9. The hearing aid device according to claim 8, wherein the Bluetooth component comprises:
a Bluetooth communication module, configured to receive the external audio signal during the operation; and
a Bluetooth signal processing circuit, electrically connected to the Bluetooth communication module, and configured to perform the second signal processing on the external audio signal during the operation and output the Bluetooth audio signal, wherein
the Bluetooth signal processing circuit is electrically connected to the hearing aid signal processing circuit to send the second control signal to the hearing aid signal processing circuit.

10. The hearing aid device according to claim 9, wherein the Bluetooth component further comprises:
a Bluetooth microphone, configured to collect the external sound during the operation and generate a Bluetooth microphone signal, wherein
the Bluetooth microphone is electrically connected to the Bluetooth signal processing circuit, and the Bluetooth signal processing circuit performs a third signal processing on the Bluetooth microphone signal during the operation to generate an output audio signal, and send the output audio signal to the Bluetooth communication module.

11. The hearing aid device according to claim 1, further comprising a battery module electrically connected to the Bluetooth component and the hearing aid component.

12. The hearing aid device according to claim 11, wherein the battery module comprises:
a rechargeable battery, electrically connected to the Bluetooth component and the hearing aid component, and configured to provide power to the Bluetooth component and the hearing aid component during the operation;
a charging protection circuit, electrically connected to the rechargeable battery; and
a voltage stabilization circuit, connecting the hearing aid component and the rechargeable battery.
